(19) United States
(12) Patent Application Publication
(10) Pub. No.: US 2023/0331024 A1
(43) Pub. Date: Oct. 19, 2023

(54) OPTICAL SECURITY FEATURE WITH EMBOSSED APPEARANCE

(71) Applicant: Precision Converting Technologies, LLC, Hudson, WI (US)

(72) Inventors: Peter J. Freyholtz, Hudson, WI (US); James P. Endle, New Richmond, WI (US)

(21) Appl. No.: 17/971,054

(22) Filed: Oct. 21, 2022

Related U.S. Application Data
(60) Provisional application No. 63/331,353, filed on Apr. 15, 2022.

(51) Int. Cl. B42D 25/373; B42D 25/328; B42D 25/455; B32B 27/36; B32B 27/08; B32B 3/08; B32B 27/30; B32B 15/09; B32B 15/082; B32B 3/30; B32B 37/06

(52) U.S. Cl. CPC B42D 25/373; B42D 25/328; B42D 25/455; B32B 27/365; B32B 27/08; B32B 3/08; B32B 27/304; B32B 27/36; B32B 15/09; B32B 15/082; B32B 3/30; B32B 37/06; B42D 25/435

(57) ABSTRACT

An optical security feature comprising a visually deformable layer disposed between two polymer layers, which are fused together by heating, thereby yielding an embossed appearance to the visually deformable layer.

### RELATED APPLICATIONS

This application claims priority to U.S. Provisional Patent Application No. 63/331,353, filed Apr. 15, 2022, the entire contents of which are incorporated herein by reference.

### TECHNICAL FIELD

This disclosure relates generally to optical security features that may be useful to authenticate items such as documents, identification cards, monetary currency, etc., and/or to thwart passing off of counterfeit goods.

### BACKGROUND

The prevalence of counterfeit products and documents is a known problem. The use of inexpensive, high quality color copiers, printers and scanners, as well as other reproduction techniques, have enabled counterfeiters to reproduce the authentication features of many items. In addition, the prevalence of low-cost, simple hologram origination has greatly reduced the value of holograms as a security feature. Because of these advancements, currency, security labels, and identification documentation have been subject to counterfeiting using similar technologies.

Items that may be the subject of attempted counterfeiting include certain types of documents (e.g., passports, identification cards, drivers' licenses, currency, title documents, etc.) and certain consumer goods (e.g., “knock-offs” of brand name items). If a document is to be protected from counterfeiting by using a security laminate, coating or covering a portion of the document for example, the laminate should allow the contents of the document to be seen through the laminate. The security laminate should also be difficult to copy. In addition, security labels used for brand protection and warranty fraud prevention must be relatively simple or easy to authenticate (e.g., preferably without requiring the use of specific tools or equipment) and difficult to replicate or simulate.

Examples of technologies used in this space to protect from counterfeiting include holograms, color-shifting inks and foils, and floating images and other micro-optics features. However, all these features have limitations in either ease of simulation/replication, difficulty of authentication, or complex, expensive manufacturing processes. Embossing is another technique that has been employed to modify and/or enhance the appearance of certain security documents. For example, embossments have been described as a way to provide additional security to security films such as colored mirror films (“CMF”) due to the different color shifts that may be observed where there are embossments. Most commercially available CMF products consist of alternating layers of polymers that provide a certain set of optical properties, and these can have value in security documents as CMF can feature color-shifting properties. The CMF embossing process has typically involved compressing certain regions of the CMF so that the color and color-shift of the film is locally changed because the layer thickness distribution is locally different, meaning CMF is thermally and visually deformable. For example, in U.S. Pat. No. 6,045,894, the embossing examples were performed with metal tooling at high temperatures and high pressure in an extra embossing process using male/female, male only, and female only dies. Using hard, immobile tooling provides embossments that mirror the tooling. This type of embossing process generated embossments with significantly thinner cross-sections (between 5 and 85%) than the rest of the film, which generates a different color-shift. However, this type of embossing process comes with significant complications, challenges, and/or costs.

While certain regions of the embossed CMF may have thinner regions when using embossing processes described in the prior art, there are also thicker regions due to displacement. This non-uniform thickness can cause challenges in converting, printing, die-cutting, coating, and other web-handling processes. In addition, when these features are later incorporated into fused documents such as fused PC documents, the embossments are typically affected (e.g., flattened) by the fused document lamination process, which often use temperatures and pressures on the order of the initial metal-tooling embossing conditions described in the art. Therefore, typically a thick, cushioning adhesive is needed to protect the CMF or other films and embossments from the document fusing process. Some security films may also delaminate, crack, or flake if not supported, especially those with metal or vacuum coatings.

There is an ongoing need for relatively inexpensive security features that are simple to authenticate (for example, by simple tilting or rotating of the feature) and simple to manufacture, yet difficult to simulate or replicate.

### SUMMARY

This disclosure describes an authentication device (which could be used in a security document, for example) comprising a visually deformable layer disposed between two polymer layers that are fused together by heating, thereby yielding an embossed appearance to the visually deformable layer. In some embodiments, a shaped cutout area in one of the layers may facilitate forming the embossed appearance in the visually deformable layer. In other embodiments, a shaped “chad” (e.g., a portion removed or cut out from a layer of material) may facilitate forming the embossed appearance in the visually deformable layer.

In some embodiments of this disclosure, an authentication device may comprise an upper layer, a middle layer, and a lower layer. The upper layer may comprise a non-opaque polymer film layer having a shaped cutout area, the middle layer may comprise a visually deformable layer sized to at least partially cover the shaped cutout area of the upper layer, and the lower layer may comprise a polymer film layer, wherein the upper and lower layers are both sized to cover the middle layer according to various embodiments. The authentication device may then be formed by positioning the middle layer between the upper and lower layers and adjacent thereto, with the middle layer positioned to at least partially cover the shaped cutout area. The upper and lower layers may then be fused together by exposing the layers (e.g., at least the upper and lower layers) to a temperature that is high enough to fuse the upper and lower layers together, with the middle layer (which includes the visually deformable layer as well) sandwiched in between the upper and lower layers. In some embodiments, this may involve exposing at least the upper and lower layers to a temperature (a “fusion” temperature) that is higher than the glass transition temperature of at least one of the two outer layers (e.g., the upper and lower layers); in some embodiments, the fusion temperature will exceed the glass transition temperature of both the upper layer and the lower layer. During this high temperature fusion, the visually deformable layer will be permanently changed and presents novel optical properties along the edge of the cutout, which also gets deformed during the fusion in a way that mirrors the visually deformable layer deformations. In some embodiments, the overall thickness of the lower layer (which may be comprised of more than one polymer film layer) may be greater than the overall thickness of the upper layer (which may be comprised of one or more non-opaque polymer film layers in addition to the non-opaque polymer film layer having the shaped cutout area, which is disposed adjacent to the middle layer).

In some embodiments of this disclosure, an authentication device may comprise a multilayer structure including a first layer comprising a first non-opaque polymer film layer, a shaped chad layer comprising a polymer film forming a shaped chad, a second layer comprising a visually deformable layer, and a third layer comprising a third polymer film layer. In some embodiments, the second layer (including the visually deformable layer) has an edge boundary sized to at least partially cover the shaped chad, and the first and third layers are both sized to cover the second layer. In some embodiments, the third layer has a thickness that is greater than the thickness of the first layer. In various embodiments, the authentication device is formed by positioning the shaped chad layer adjacent the second layer so that the second layer edge boundary at least partially covers the shaped chad layer. The first layer is positioned adjacent the shaped chad layer, the third layer is positioned adjacent the second layer, and the first and third layers are exposed to a temperature (e.g., a fusion temperature) that is higher than the glass transition temperature of either the first layer or the third layer, or possibly higher than the glass transition temperature of both the first and third layers. During this high temperature fusion, the visually deformable layer will be permanently changed and presents novel optical properties along the edge of the chad, which also gets deformed during the fusion in a way that mirrors the visually deformable layer deformations.

In some embodiments of this disclosure, a method of manufacturing an authentication device may comprise forming a multilayer structure by providing an upper layer comprising a first non-opaque polymer film layer having a shaped cutout area, providing a middle layer comprising a visually deformable layer, providing a lower layer comprising a second polymer film layer, positioning the middle layer between the upper and lower layers so that the middle layer at least partially covers the shaped cutout area of the upper layer, and heating to a temperature sufficient to fuse the upper and lower layers together (e.g., above the glass transition temperature of at least one or the other of the upper and lower layers). In some embodiments, the fusing process results in deformation of the visually deformable layer of the middle layer to produce an embossed appearance and/or other noticeable optical effects.

In some embodiments of this disclosure, a method of manufacturing an authentication device may comprise forming a multilayer structure by providing a first layer comprising a first non-opaque polymer film layer, providing a shaped chad layer comprising a polymer film forming a shaped chad, providing a second layer comprising a visually deformable layer, providing a third layer comprising a third polymer film layer, positioning the shaped chad layer and the second layer adjacent one another with the second layer at least partially covering the shaped chad, positioning the first layer adjacent the shaped chad layer, and positioning the third layer adjacent the second layer, with each of the first and third layers sized to cover the second layer. The authentication device is then formed by heating to a temperature sufficient to fuse the first and third layers together (e.g., above the glass transition temperature of at least one or the other of the first and third layers). In some embodiments, the fusing process results in deformation of the visually deformable layer of the second layer to produce an embossed appearance and/or other noticeable optical effects.

### BRIEF DESCRIPTION OF DRAWINGS

FIG. 1A is an exploded perspective view of elements used to form an authentication device in accordance with some embodiments of this disclosure;

FIG. 1B is top plan view of an authentication device formed in accordance with some embodiments of this disclosure;

FIG. 2A is a cross-sectional view of elements used to form the authentication device of FIGS. 1A and 1B in accordance with some embodiments of this disclosure;

FIGS. 2B-2D are cross-sectional views of elements used to form an authentication device according to various embodiments of this disclosure;

FIG. 2E is a cross-sectional view of an authentication device formed in accordance with various embodiments of this disclosure;

FIG. 2F is an annotated scanning electron micrograph image of a cross-section of an authentication device formed in accordance with various embodiments of this disclosure and pulled straight;

FIG. 2G is a cross-sectional view of an authentication device formed in accordance with some alternate embodiments of this disclosure;

FIGS. 3A and 3B are top perspective views (from different viewing angles) showing a changing optical appearance or effect of an authentication device upon a change of viewing angle according to some embodiments of this disclosure;

FIG. 4A is an exploded perspective view of elements used to form an authentication device in accordance with some embodiments of this disclosure;

FIGS. 4B and 4C are top plan views of the authentication device of FIG. 4A formed in accordance with some embodiments of this disclosure;

FIG. 5A is an exploded perspective view of elements used to form an authentication device in accordance with some embodiments of this disclosure;

FIG. 5B is a cross-sectional view of an authentication device formed in accordance with some embodiments of this disclosure;

FIG. 6A is a before and after schematic cross-sectional view of an authentication device being formed in accordance with some embodiments of this disclosure;

FIG. 6B is a before and after top view of an authentication device being formed in accordance with some embodiments of this disclosure;

FIG. 7A is a before and after schematic cross-sectional view of an authentication device being formed in accordance with some embodiments of this disclosure; and

FIG. 7B is a before and after top view of an authentication device being formed in accordance with some embodiments of this disclosure.

### DETAILED DESCRIPTION

This disclosure describes an authentication device or security feature (which could be used in a security document, for example) comprising a visually deformable layer disposed between polymer layers that are fused together, thereby yielding an embossed appearance to the visually deformable layer. In some embodiments, a shaped cutout area in one of the layers may facilitate forming the embossed appearance in the visually deformable layer upon fusing. In some embodiments, a shaped “chad” in one of the layers may facilitate forming the embossed appearance in the visually deformable layer upon fusing.

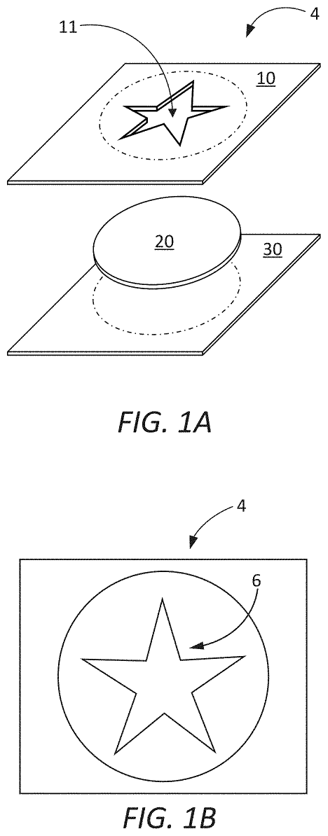

FIG. 1A is an exploded perspective view of a number of elements that may be used to form an authentication device 4 in accordance with some embodiments of this disclosure. For example, an embossment effect may be formed in a security film (“SF”) by using an arrangement of elements and a fusing or lamination process in accordance with this disclosure. FIG. 1B is a top view of the authentication device 4, highlighting a region of embossment 6 formed during the fusing process. It is worth noting that if the authentication device 4 of FIG. 1B is viewed from the top, it will appear embossed (e.g., pushed upward). If the layers are clear in the area of the embossment and it is viewed from the bottom, it will appear to be debossed (e.g., pushed downward). In FIG. 1A, an authentication device 4 may be formed of an upper layer 10, a middle layer 20, and a lower layer 30.

In the example shown in FIG. 1A, upper layer 10 comprises a first non-opaque polymer film layer having a shaped cutout area 11 disposed therein. There could be more than one shaped cutout area 11 in this layer, for example, and the shape chosen for the shaped cutout area 11 happens to be a star-shaped cutout area 11, but could vary as desired (e.g., letter, logo, arbitrary shape, design, image, etc.). In the example of FIG. 1A, upper layer 10 comprises only a single layer (e.g., the first non-opaque polymer film layer with the shaped cutout area 11). However, various embodiments of this disclosure describe an upper layer 10 having one or more additional non-opaque polymer film layers (e.g., in addition to the first non-opaque polymer film layer with the shaped cutout area 11). In some cases, the additional non-opaque polymer film layers are disposed adjacent a “top” side (or “second side”) of the first non-opaque polymer film layer having the shaped cutout area 11 (e.g., disposed opposite the middle layer 20) and may not themselves include shaped cutout areas (e.g., the additional non-opaque polymer film layers may be flat, continuous layers). Upper layer 10 may have a first thickness and an upper layer area. In this context, the first thickness of upper layer 10 describes the thickness of all of the component layers of upper layer 10, which could be as few as just one layer (e.g., the first non-opaque polymer film layer with the shaped cutout area 11), or many layers in addition to the first non-opaque polymer film layer, as will be described in more detail below.

In some embodiments, the first non-opaque polymer film layer may comprise a transparent polymer film layer. In some embodiments, one or more of the additional non-opaque polymer film layers may comprise a transparent polymer film layer. It should be noted that the use of the term “non-opaque” throughout this disclosure is meant to describe a wide range in the amount of light transmission through a layer, from “almost opaque” to fully transparent, and everything in between.

Middle layer 20 of authentication device 4 comprises a “visually deformable layer.” The visually deformable layer is constructed to generate an optical artifact when embossed, which may cause a localized thinning or shape such that shadows may be formed. Preferably, the visually deformable layer will be thermally deformed during the embossing process, which means the visually deformable layer preferably contains at least one polymer component with a glass transition temperature similar to or slightly below the fusion temperature, making it a thermally deformable layer at the temperature of fusion. The visually deformable layer may be colored by dye or structure, such as diffraction gratings or similar technologies known to those in the art. In a preferred example, the visually deformable layer may be comprised of a colored mirror film (“CMF”), according to various embodiments. As used herein, a CMF film comprises a multilayer optical film that extends from a first major surface to a second major surface (e.g., across its thickness), the multilayer optical film made up of alternating first and second optical polymeric layers, wherein each of the first optical polymeric layers has a first refractive index, and wherein each of the second optical polymeric layers has a second refractive index different from the first refractive index. The visually deformable layer may also be a polymer layer with a thin layer of metal deposited on the surface (e.g., vapor-deposited metal). The metal of this deposition could be silver, aluminum, gold, copper, or any other metal that can applied in a layer thin enough to be deformable during the fusion/embossing operation of this disclosure. As the metal layer is deformed and bent by the deformation process, the metal interacts with light differently as a 3D image is formed by shadows in a way similar to other metal embossing effects. Other visually deformable layers are also possible, such as pigmented, patterned, or printed films, films with diffractive elements or coatings, paper or other opaque films, etc. The middle layer 20 has a thickness (e.g., a “second thickness”) and extends across an area (a “middle layer area,” the size of which is indicated by dashed lines) sized to at least partially cover the shaped cutout area 11, as is depicted in FIG. 1A. For example, the visually deformable layer may be sized to encompass an outer edge boundary of the shaped cutout area 11 according to some embodiments. In some embodiments, the visually deformable layer is deformed somewhat during the process of fusing or laminating the layers together to form the authentication device 4. The deformation of the visually deformable layer typically occurs along the boundary of the shaped cutout area 11 thereby creating an optical effect resembling an embossment.

Lower layer 30 of authentication device 4 comprises a polymer film layer (a “second polymer film layer”). Lower layer 30 extends across an area (a “lower layer area”) and has a thickness (a “third thickness”), which may be equal to or greater than the first thickness of the upper layer 10. In some embodiments, both the upper layer area and the lower layer area are sized and/or positioned to cover the middle layer area, as in the example shown in FIG. 1A.

The authentication device 4 may be formed by positioning the various layers as described and shown, then heating to cause certain layers to fuse together. For example, the “top” side (“second side”) of middle layer 20 may be positioned adjacent the “bottom” side (“first side”) of the first non-opaque polymer film layer of the upper layer 10 to at least partially cover the shaped cutout area 11. (NOTE: For consistency throughout this disclosure, the “first side” of a given layer will refer to the “bottom” side of that layer, and the “second side” will refer to the “top” side of that layer, as the various embodiments are shown and described herein.) The bottom side (first side) of the middle layer 20 may be positioned adjacent the top side (second side) of the lower layer 30 (e.g., adjacent the second polymer film layer of the lower layer 30). It should be noted that the order of performing the positioning steps is not important; the order may be altered and/or reversed, for example. Once the layers are positioned as described above, at least the upper layer 10 and the lower layer 30 are exposed to a temperature (a “fusion temperature”) that results in the upper layer 10 and lower layer 30 fusing together. In various embodiments, the fusion temperature to which the layers are exposed is greater than the “glass transition temperature,” or “T_{g},” of at least one of the upper layer 10 and the lower layer 30. In some cases, for example, it may be desirable to raise the temperature above the T_{g} of both the upper and lower layers 10, 30. In other cases, it may be desirable to raise the temperature above the T_{g} of only one of the layers 10, 30.

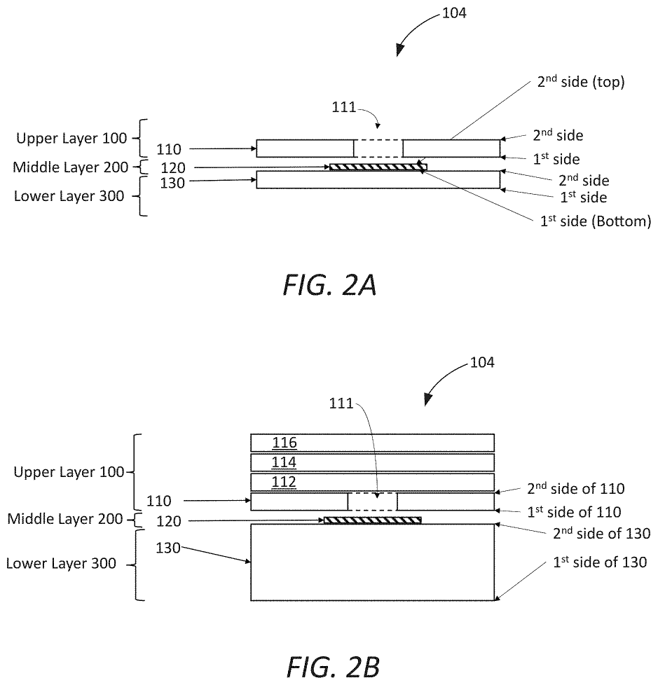

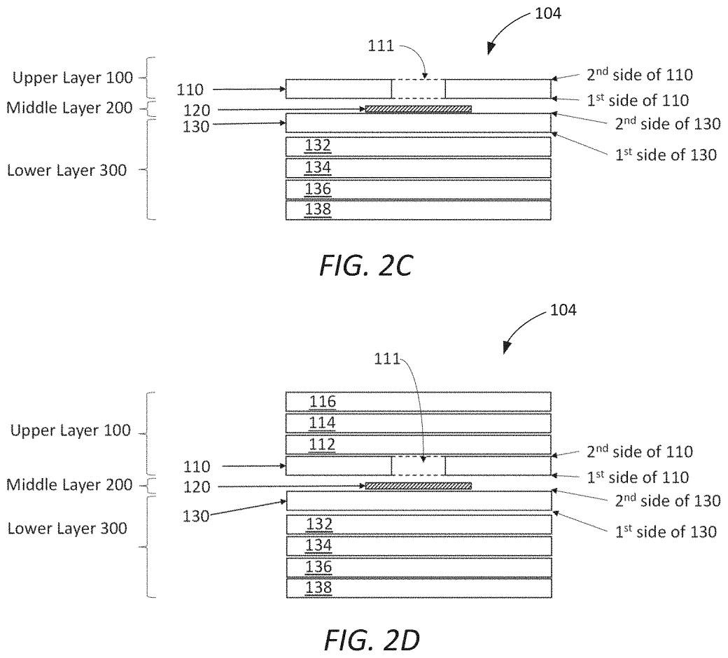

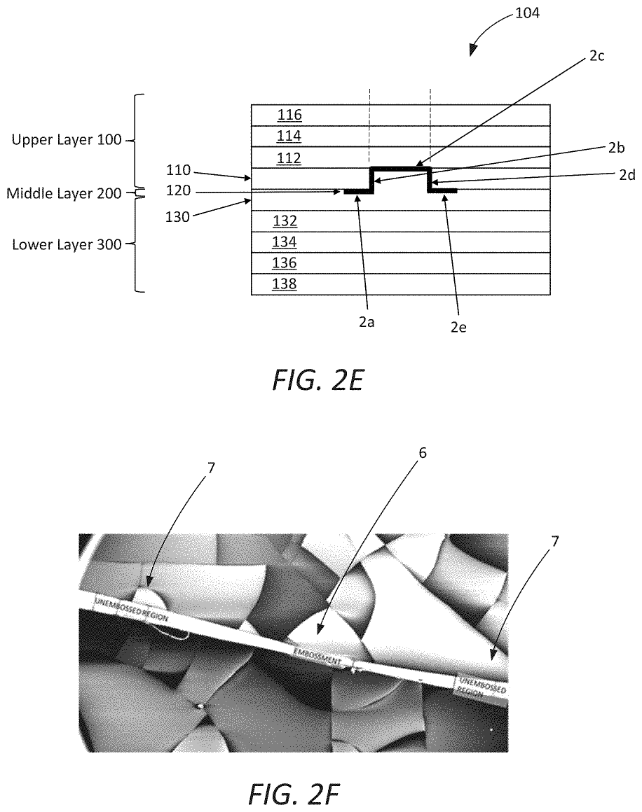

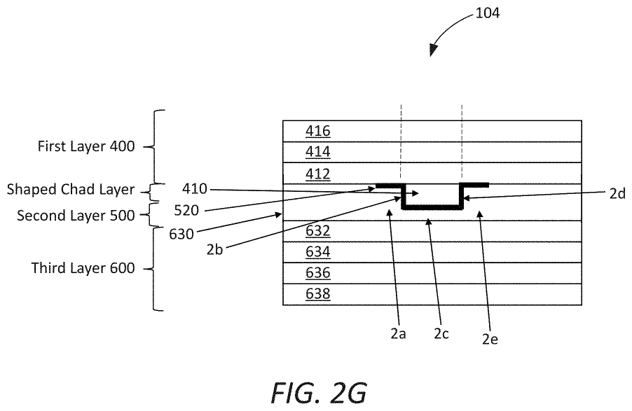

When the fusing of the upper and lower layers 10, 30 is complete, the visually deformable layer (of middle layer 20) may deform to thereby generate an optical effect for authentication device 4. In various embodiments, the visually deformable layer may deform along a boundary of the shaped cutout area thereby creating an optical effect resembling an embossment. This embossing effect may be caused by the heat and/or pressure of the fusing process locally bending and modifying the visually deformable layer near the edges of the shaped cutout area as the polymer material around the cutout area softens over a period of time, which may range from multiple seconds to several minutes, according to some embodiments. Raising the temperature above the T_{g} of at least one of the upper and lower layers 10, 30 may cause the affected layer(s) to become rubbery and flow; however, unexpectedly, the affected layer(s) may still retain enough mechanical integrity to emboss (e.g., cause deformation to) the middle layer 20. In order to facilitate the affected polymer layers becoming rubbery when heated to the fusion temperature (and not becoming a low-viscosity fluid), the fusion temperature employed should be limited to less than about 80 C above the T_{g} of the polymer layer(s), and preferably less than 40 C above the T_{g} of the polymer layer(s). In some embodiments, the visually deformable layer could be embedded within one of the layers of the authentication device 4 (e.g., within the second polymer film layer of the lower layer 30, for example). An example of a visually deformable layer that has been embossed using this process is provided in FIG. 2F, which is a scanning electron micrograph (SEM) image of a cross-section of an embossed visually deformable layer that was removed from a document created using the methods disclosed herein and straightened for easier microscopy. The embossed region 6, labeled “EMBOSSMENT,” is clearly thinner than the unembossed regions 7, labelled “UNEMBOSSED REGION.” Unexpectedly, unlike the prior art regarding embossing of CMF, the visually deformable layer in this case is not so much compressed as it is stretched due to its attempt to conform to either the cutout or the chad, so there is only a thinner region and not a thicker region for visually deformable layers embossed using conventional embossing technology. The resulting embossment effect may be indelible, similar to that produced using a metal tool, for example, although it may provide advantages and differences in appearance not found using traditional embossment techniques. Unexpectedly, when the lower layer 30 is the same thickness or thicker than the upper layer 10, the optical effect generated may be much greater (e.g., more noticeable or more pronounced) than when the lower layer 30 is thinner than the upper layer 30.

FIG. 2A is a cross-sectional view of the various layers and components used to form an authentication device 104 similar to device 4 shown in FIGS. 1A and 1B. In FIG. 2A, upper layer 100 comprises a first non-opaque polymer film layer 110 having a first thickness, an upper layer area, and at least one shaped cutout area 111 disposed therein. In some embodiments, first non-opaque polymer film layer 110 may be a transparent polymer film layer; alternately, first non-opaque polymer film layer 110 may be translucent, for example. In FIG. 2A, middle layer 200 comprises visually deformable layer 120, the middle layer 200 having a second thickness and a middle layer area sized to at least partially cover the at least one shaped cutout area 111 of layer 110. In the particular examples depicted in the accompanying drawing figures, middle layer area is sized to encompass the shaped cutout area 111 of layer 110. In some embodiments, the visually deformable layer 120 may comprise a colored mirror film (“CMF”); in other embodiments, the visually deformable layer 120 may comprise a vapor-coated metal layer. In FIG. 2A, lower layer 300 comprises second polymer film layer 130, the lower layer 300 having a thickness (a “third thickness”) that is equal to or greater than the first thickness of the upper layer 100. The upper layer area and the lower layer area may be sized to cover the middle layer area. As shown in FIG. 2A, each of the layers is shown having a corresponding first side (bottom side) and second side (top side).

The authentication device 104 of FIG. 2A is formed in substantially the same manner as described above with respect to authentication device 4 of FIG. 1A. That is, second side of middle layer 200 may be positioned adjacent the first side of the first non-opaque polymer film layer 110 of the upper layer 100 to at least partially cover the shaped cutout area 111. The first side of the middle layer 200 is positioned adjacent the second side of the lower layer 300 (e.g., adjacent the second side of the second polymer film layer 130 of the lower layer 300). It should be noted that the order of performing the above-mentioned positioning steps is not important; the order may be altered and/or reversed, for example. Once the layers are disposed as described above, at least the upper layer 100 and the lower layer 300 are exposed to a temperature (e.g., a “fusion” temperature) and a pressure that results in the upper layer 100 and lower layer 300 fusing together. The fusion temperature is greater than the glass transition temperature (T_{g}) of at least one of the upper layer 100 and the lower layer 300, and may be greater than the T_{g} of both the upper and lower layers 100, 300. When the fusing of the upper and lower layers 100, 300 is complete, the visually deformable layer 120 (of middle layer 200) may deform to thereby generate an optical effect for authentication device 104.

FIGS. 2B-2D are cross-sectional views of the various layers and components used to form an authentication device 104 according to several additional embodiments of this disclosure.

For example, the authentication device 104 of FIG. 2B is similar to that depicted in FIG. 2A, except that one or more additional non-opaque polymer film layers (e.g., layers 112, 114, and 116 in FIG. 2B) are disposed adjacent a second side of first non-opaque polymer film layer 110 of upper layer 100. In certain alternate embodiments, at least one of the first non-opaque polymer film layer 110 and the one or more additional non-opaque polymer film layers 112, 114, 116 of the upper layer 100 may include a security feature such as a print, a hologram, and/or a color-shifting foil, or a combination thereof. Other security components, adhesives, layers, or coatings that are known in the art could be added to any surface. These components could be printed elements, diffractive structures, durable coatings, security fibers or threads, fragile tamper-indicating layers, taggants, micro-optics, security inks, laserable additives, and the like. These security components could feature either personalized or customized designs or artwork.

In certain alternate embodiments, at least one of the first non-opaque polymer film layer 110 and the one or more additional non-opaque polymer film layers 112, 114, 116 of the upper layer 100 may be formed of a material selected from the group consisting of polycarbonate, polyvinyl chloride (“PVC”), and polyester, and/or other non-opaque materials used in secure document construction, for example. In FIG. 2B, it should be noted that lower layer 300, as shown, is comprised of a single layer (e.g., second polymer film layer 130). Second polymer film layer 130 in such an embodiment is depicted in FIG. 2B such that lower layer 300 (comprised only of second polymer film layer 130 in this example) has a thickness that is at least equal to or greater than the overall thickness of upper layer 100 (which is comprised of layers 110, 112, 114, and 116 in this example).

The authentication device 104 depicted in FIG. 2C is similar to that depicted in FIG. 2A, except that one or more additional polymer film layers (e.g., layers 132, 134, 136 and 138 in FIG. 2C) are disposed adjacent a first side of the second polymer film layer 130. In some embodiments, lower layer 300 (comprised of second polymer film layer 130 plus layers 132, 134, 136 and 138 in this example) has a thickness that is at least equal to or greater than the thickness of upper layer 100 (which comprises the single first non-opaque polymer film layer 110 in this example). In certain alternate embodiments, the second polymer film layer 130 and/or one or more of the additional polymer film layers 132, 134, 136 and 138 of the lower layer 300 may include a security feature such as a print, a hologram, and/or color-shifting foils, or a combination thereof. In certain alternate embodiments, the second polymer film layer 130 and/or one or more of the additional layers 132, 134, 136 and 138 of the lower layer 300 may be formed of a material selected from the group consisting of polycarbonate, polyvinyl chloride (“PVC”), polyester, Teslin® or other waterproof synthetic printing medium, and/or other materials used in secure document construction, such as paper or adhesives.

The authentication device 104 depicted in FIG. 2D is similar to that depicted in FIG. 2A, except that additional layers have been added to both the upper layer 100 and lower layer 300. For example, one or more additional non-opaque polymer film layers (e.g., layers 112, 114, and 116 in FIG. 2D) are disposed adjacent a second side of first non-opaque polymer film layer 110, and one or more additional polymer film layers (e.g., layers 132, 134, 136 and 138 in FIG. 2D) are disposed adjacent a first side of the second polymer film layer 130. In some embodiments, lower layer 300 (comprised of second polymer film layer 130 plus layers 132, 134, 136 and 138 in this example) has a thickness that is at least equal to or greater than the thickness of upper layer 100 (comprised of first non-opaque polymer film layer 110 plus layers 112, 114, and 116 in this example). In some embodiments, an adhesive may be applied between the upper layer 100 and the middle layer 200, and/or between the middle layer 200 and the lower layer 300, in order to facilitate positioning of the middle layer 200 relative to the shaped cutout area 111, for example, or to facilitate positioning of the middle layer 200 relative to the lower layer 300, etc. Other variations, including different numbers of additional layers for example, would be apparent to those of ordinary skill with the benefit of these teachings, and would be deemed to be within the scope of this disclosure.

It should be noted that a further alternate embodiment may be formed, which resembles the configuration shown in FIG. 2C; in other words, an embodiment having a single layer 110 with a shaped cutout area 111 on one side of the visually deformable layer 120. However, it is possible that an opaque polymer film layer (rather than a non-opaque polymer film layer) may be used to form such an embodiment with similar embossing effect as that described with respect to FIGS. 2A-2D. Many of the other variations described herein could be applied to such an embodiment by those of ordinary skill in the art with similar resulting effect, and such variations would be deemed to be within the scope of this disclosure.

With further reference to FIG. 2D, when the construction of FIG. 2D is fused together, the layers observing enough heat to exceed their T_{g} will soften and flow or move. In particular, the layers near the shaped cutout area 111 that are above their T_{g} will tend to flow to fill at least part of shaped cutout area 111. As a result, second polymer film layer 130 opposite shaped cutout area 111 will push into the visually deformable layer 120 (e.g., upwards in FIG. 2D) toward the shaped cutout area 111. In addition, if any of the layers 110, 112, 114, and 116 of upper layer 100 are above their respective T_{g}'s, they will also flow into the shaped cutout area 111. These competing forces will deform the visually deformable layer 120 into a unique shape as schematically shown in FIG. 2E. This shape and deformation mean that the deformation of the security document or authentication device 104 will feature a customized internal shape that may complement the shape of the visually deformable layer 120. Unexpectedly, this means that the thickness of upper layer 100 will no longer be uniform across the entire width of the authentication device 104, and the thickness of lower layer 300 will no longer be uniform across the entire width of the authentication device 104. Instead, as shown schematically in FIG. 2E, the thickness (e.g., a “fifth” thickness) of upper layer 100 immediately above the edge sections 2a and 2e will be thicker than the thickness (e.g., a “fourth” thickness) of upper layer 100 immediately above the middle section 2c, and the thickness of lower layer 300 immediately below the edge sections 2a and 2e will be thinner than the thickness of lower layer 300 immediately below the middle section 2c. In addition, since the visually deformable layer is not only embossed, but now features a 3D shape due to the more vertical sections 2b and 2d of FIG. 2E, additional optical features such as the formation of shadows is provided by this construction. In some embodiments, there may be a pocket of air that remains adjacent the visually deformable layer where the shaped cut-out area 111 previously existed; in other embodiments, no such pocket of air will persist (e.g., the air pocket may be removed due to the flowing and/or movement of material that occurs during the fusing/lamination process). This cut-out area would typically contain less material than the adjacent regions of the fused authentication device or document following the fusing/lamination process.

Unlike embossing operations of security films described in the prior art, these embossments are formed in situ. This provides manufacturing advantages over pre-embossing as it requires fewer manufacturing operations. In addition, while pre-embossed foils can become modified during the fusing operations of standard security document manufacture, in situ embossments may tend to remain more sharp and/or more clearly defined. In addition, there are security benefits to this embossing process. For example, if an attempt is made to harvest the visually deformable layer 120 in FIG. 2E and fraudulently place this layer in another document, the shape of layer 120 described by 2a, 2b, 2c, 2d, and 2e in FIG. 2E will be modified during the extraction and re-insertion processes, changing the optical effect dramatically and thereby providing an indication and/or evidence of tampering.

As upper layer 100 and lower layer 300 of the security document or authentication device 104 shown in FIG. 2E may be customized by the embossing process in a similar manner to the customization of the visually deformable layer 120, this aspect may thereby provide for an additional level of security or authentication, such as tamper evidence or tamper detection. For example, if a would-be counterfeiter were to successfully remove the visually deformable layer 120, the layers 120, 100, and 300 would all be customized (e.g., deformation would be present in these layers). Therefore, any attempts to replace the original visually deformable layer 120 with a different layer within the tampered security document and re-fuse the structure, or to place different upper and lower layers around the removed visually deformable layer 120 and re-fuse the structure, would yield a visually different construction, providing evidence of the tampering and alerting the authenticator to an issue or error or attempted counterfeit or fraud.

In addition, the embossed visually deformable layer 120 shown in FIG. 2E would have a distinctly different structure than what is currently known in the art. In the embodiments of this disclosure, the embossment would typically include a stretched thermally and/or visually deformable layer in the regions of the embossment. For example, the length of the visually deformable layer 120 is different before and after the fusing process, as shown in FIGS. 2D and 2E, owing to the generation or formation of vertical sections 2b and 2d in visually deformable layer 120. The vertical sections 2b and 2d may become thinner than the edge/middle sections 2a, 2c, and 2e during the embossing process. In addition, this embossing process would have a very different set of forces and thermal activity than what is described in the prior art, generating unique resultant structures. Unlike the prior art, the embossments described in this disclosure may include smooth transitions between the unembossed regions (Sections 2a, 2c, and 2e) and the embossed regions (Sections 2b and 2d), as shown in the scanning electron micrograph image of FIG. 2F, where the embossment 6 might correspond to, for example, vertical section 2b or 2d, and the unembossed regions 7 might correspond to, for example, edge/middle section 2a, 2c, or 2e. The embossing structures, methods, and processes of this disclosure unexpectedly provided different visual effects than what is described in the prior art.

FIG. 2G is a cross-sectional view of an authentication device 104 formed in accordance with an alternate embodiment of this disclosure. Specifically, the authentication device 104 of FIG. 2G differs from the authentication device 104 of FIG. 2E in that it employs a shaped chad layer 410 rather than the shaped cutout area 111 of layer 110 of the embodiment shown in FIG. 2E. The foregoing discussion with respect to FIG. 2E regarding the deformation of the visually deformable layer is applicable to the corresponding aspects of the embodiment shown in FIG. 2G (e.g., layer 520 in FIG. 2G).

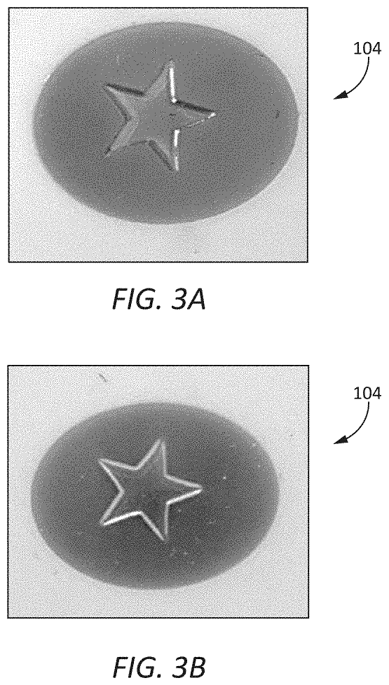

FIGS. 3A and 3B are top perspective views of an authentication device 104 as viewed from two different viewing angles, showing a three-dimensional (“3D”) effect and/or a changing optical appearance or effect that may be due to a property of the visually deformable layer, further enhanced by the effect of the resulting embossment effect according to some embodiments of this disclosure.

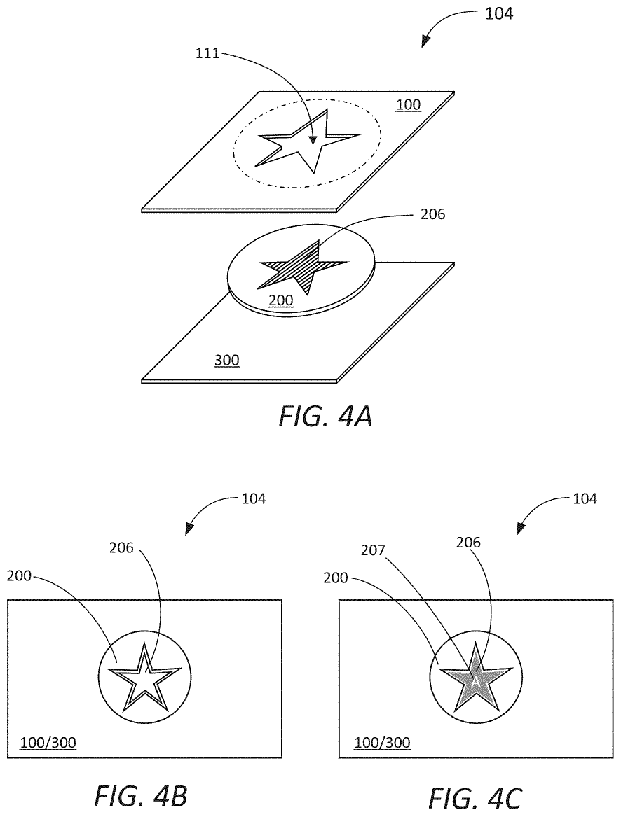

FIG. 4A is an exploded perspective view of elements used to form an authentication device 104 in accordance with some further embodiments of this disclosure. For example, in FIG. 4A, the visually deformable layer (middle layer 200 in FIG. 4A) may be comprised of a CMF, which might be printed, coated, primed, or laser marked. The print, coating, or marking might offer some kind of tie to the cut-out, such as a matching or complementary pattern. For example, in FIG. 4A, middle layer 200 is printed or coated with a laser-imagable coating 206 that is sized and/or shaped to match (or otherwise complement) the size and/or shape of the shaped cutout area 111 of the first non-opaque polymer film layer of the upper layer 100 as shown in the exemplary embodiment of FIG. 4A. Similarly, one or more of the component layers of upper layer 100 and/or lower layer 300 could be printed, laser marked, or modified to produce a matching or complementary pattern to the shaped cutout area 111 according to certain alternate embodiments. In some embodiments, the visually deformable layer of middle layer 200 may be comprised of a vapor-coated metal layer 206 and a CMF layer; in such a configuration, a portion of the vapor-coated metal layer 206 may be removed (e.g., using a laser etching process) after the upper layer 100 and the lower layer 300 have been fused together.

With further reference to FIG. 4A, the coating 206, which may be laser-imagable, may be disposed on a second side of middle layer 200 as shown. Coating 206 may partially or fully cover the CMF (visually deformable layer) and may consist of ink or metal, or similar materials that will ablate (e.g., be removed) or change color when laser etching or laser imaging is performed thereon. The CMF portion of middle layer 200 may or may not be laser imagable itself. After the fusing/laminating process which would cause the embossment effect, the coating 206 could be laser etched/imaged, generating a customized or personalized image. Examples of embodiments formed per FIG. 4A are shown in the top views of FIGS. 4B and 4C, where the middle layer 200 (e.g., comprising a CMF layer positioned as shown in FIG. 4A) is coated with a laser-imagable layer or coating 206 having a star-shaped pattern (as seen in FIGS. 4A-4C), prior to positioning and incorporating it into the arrangement of elements shown in FIG. 4A. Coating 206 may then be laser-imaged (or laser etched) with a letter “A” in this example, removing the coating material 206 as needed to form the desired “A” pattern 207 in this example, as shown in FIG. 4C.

If this construction were formed in a window, the region of the CMF exposed during laser imaging would feature interesting transmission vs. reflection optics. A CMF that has been pre-embossed using traditional embossing techniques known and described in the art would be difficult to print or coat; by contrast, the technique described herein would enable the use of laser-imagable, embossed CMF with significantly easier manufacturing. The CMF, for example, could be embedded within a layer of a document or device, or could be disposed on the surface of the document or device, etc., according to various embodiments. Another embodiment could involve the use of a CMF as part of middle layer 200 that is also laser-responsive, such as that described in US 2011/0255167. In some embodiments, a vapor-coated metal layer may be employed rather than the CMF. Yet another embodiment similar to the ones shown in FIGS. 4A-4C may include the use of a metallized patch as the visually deformable layer of middle layer 200, where a laser etching process is used to etch away the metal to form the desired pattern or shape. In this case, the metal layer may be etched/ablated as described in EP 2665607. Any of the lasered artwork in any of these embodiments could be personalized (e.g., with some document-holder's biometric information or images), or the artwork could be common to all or a specific subset of the documents, such as a flag or state outline or corporate seal, etc. The use of a laser-imagable element in forming an authentication device 104 could apply, for example, to other aspects of the process using CMF and/or metallized film, for example.

FIG. 4B is a top plan view of the authentication device 104 of FIG. 4A formed in accordance with some embodiments of this disclosure. For example, FIG. 4B shows device 104 having a laser-imagable layer or coating 206 having a star-shaped pattern formed on middle layer 200 within the area defined by the shaped cutout area 111. FIG. 4C is a top plan view of the authentication device 104 of FIGS. 4A and 4B after a laser etching or laser imaging process is used to ablate or remove portions of the coating 206 from middle layer 200 to form a pattern such as pattern 207 (letter “A” in FIG. 4C). In embodiments where middle layer 200 comprises a CMF, for example, the etched pattern 207 may yield an additional optical effect that may be useful for authentication purposes.

It should be noted that the various embodiments of the authentication devices 4, 104, 204, etc., disclosed herein may be formed as a stand-alone component, or in a card (ID card, credit card, etc.), or incorporated within or as part of a security identification document, or as part of other types of documents, etc.

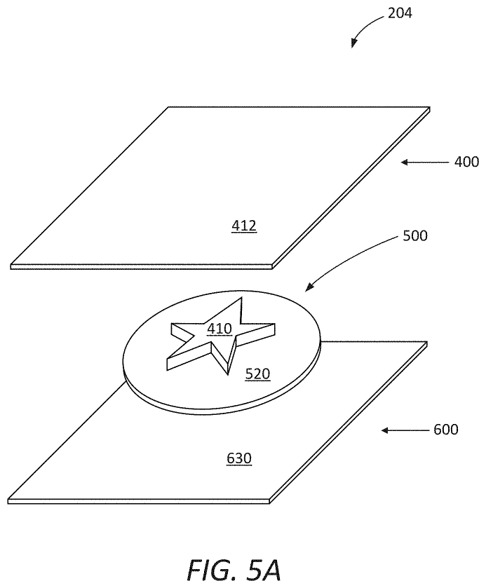

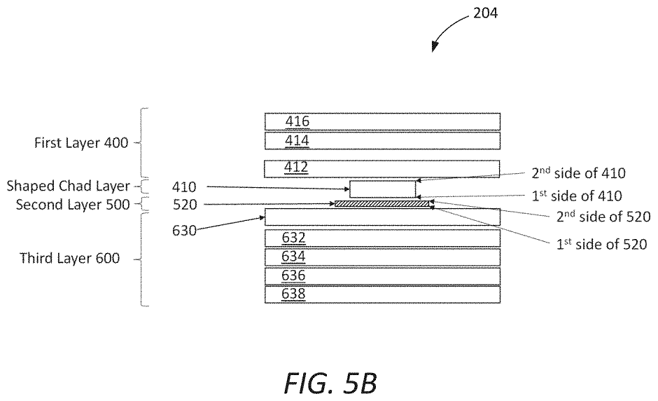

FIG. 5A is an exploded perspective view of elements used to form an authentication device 204 in accordance with an alternate embodiment of this disclosure. For example, rather than using a shaped cutout area to form the desired embossment shape, as in the above-described embodiments, a shaped “chad” layer 410 is employed to produce a similar optical embossment effect in some embodiments, where a chad is a portion of film of given thickness that has been cut out from another film. As shown in FIG. 5A, authentication device 204 may comprise shaped chad layer 410 having a first side (bottom) and a second side (top), a first layer 400 disposed adjacent the second side of the shaped chad layer 410, a second layer 500 disposed adjacent the first side of the shaped chad layer 410, and a third layer 600 disposed adjacent a first side of the second layer 500.

FIG. 5B is a cross-sectional view of an authentication device 204 similar to that shown in FIG. 5A, formed in accordance with some further embodiments of this disclosure. FIG. 5B shows additional component layers of first layer 400 and third layer 600 that may be optionally added to form various embodiments. When positioned as depicted in FIGS. 5A and/or 5B, the authentication device 204 is formed by exposing at least the first layer 400 and the third layer 600 to a temperature (e.g., a fusion temperature) that is higher than the T_{g} of either the first layer 400 or the third layer 600, or in some cases, a fusion temperature higher than the T_{g} of both the first layer 400 and the third layer 600, or in some cases, a fusion temperature higher than the T_{g} of the first layer 400, the third layer 600, and the chad layer 410. During fusion, the chad layer 410 may also deform and/or become fused to the first layer 400. In a preferred embodiment, the chad layer 410 is designed to fuse to the upper layer 400 during the fusion process, for example, by being of similar composition to that of layer 400.

With continued reference to the authentication device 204 of FIGS. 5A and 5B, the shaped chad layer 410 may comprise a polymer film having a chad first side (bottom) and a chad second side (top), a chad thickness and a shaped chad area. There could be more than one shaped chad in this layer, for example, and the shape(s) chosen for the shaped chad layer 410 happens to be a star-shape in FIG. 5A, but this could be varied as desired (e.g., letter, logo, arbitrary shape, design, image, etc.). First layer 400 may have a first thickness and a first layer area; in some embodiments, first layer 400 may comprise a first non-opaque polymer film layer 412, as shown. Second layer 500 may have a first side (bottom) and a second side (top) and may comprise a visually deformable layer 520. Second layer 500 may have a second thickness and a second layer area with a second layer edge boundary that is sized to at least partially cover the shaped chad layer 410. In the example depicted in FIG. 5A, second layer 500 is circular in shape and has a second layer edge boundary that fully encompasses the star-shaped pattern of the shaped chad area. Third layer 600 may comprise a third polymer film layer 630 having a third layer area sized to cover the second layer area. Third layer 600 may have a third thickness that is equal to or greater than the first thickness of first layer 400. This thickness relationship may facilitate the fusing/laminating process, for example.

The authentication device 204 of FIGS. 5A and/or 5B may be formed by positioning the chad first side of the shaped chad layer 410 adjacent the second side of the second layer 500 so that the second layer edge boundary at least partially covers the shaped chad layer. The chad second side of the shaped chad layer 410 may be positioned adjacent the first side of the first non-opaque polymer film layer 412 of the first layer 400. The third polymer film layer 630 of the third layer 600 may be positioned adjacent the first side of the second layer 500 to cover the second layer area. When the various layers have been positioned as described above, they are heated or exposed to a temperature (e.g., a fusion temperature) sufficient to cause the first layer 400 and the third layer 600 to fuse together. This may occur, for example, by exposing at least the first layer 400 and the third layer 600 to a fusion temperature that is higher than the T_{g} of at least one of the first layer 400 and the third layer 600.

With reference to FIG. 5B, the first layer 400 may, in some embodiments, comprise one or more additional non-opaque polymer film layers (e.g., layers 414 and 416) disposed adjacent the second side of the first non-opaque polymer film layer 412 of the first layer 400. In some embodiments, the first non-opaque polymer film layer 412 and/or one or more of the additional non-opaque polymer film layers 414, 416 may further comprise a security feature, such as a print, hologram, and/or a color-shifting foil. Other security components, adhesives, layers, or coatings that are known in the art could be added to any surface. These components could be printed elements, diffractive structures, durable coatings, security fibers or threads, fragile tamper-indicating layers, taggants, micro-optics, security inks, laserable additives, and the like. These security components could feature either personalized or customized designs or artwork.

Additionally and/or optionally, the first non-opaque polymer film layer 412 and/or one or more of the additional non-opaque polymer film layers 414, 416 of the upper layer 400 may be formed of a material selected from the group consisting of polycarbonate, polyvinyl chloride (“PVC”), and polyester, and/or other non-opaque materials used in secure document construction, according to various embodiments. The third layer 600 may, in some embodiments, comprise one or more additional polymer film layers (e.g., layers 632, 634, 636, and 638) disposed adjacent the first side of the third polymer film layer 630 of the third layer. In some embodiments, the third polymer film layer 630 and/or the additional polymer film layers (e.g., layers 632, 634, 636, and 638) of third layer 600 may further comprise a security feature, such as a print, hologram, and/or a color-shifting foil. Additionally and/or optionally, the third polymer film layer 630 and the one or more additional polymer film layers 632, 634, 636, and 638 of the third layer 600 may be formed of a material selected from the group consisting of polycarbonate, polyvinyl chloride (“PVC”), polyester, and Teslin® or other waterproof synthetic printing medium, and/or other materials used in secure document construction, such as paper or adhesives. Authentication device 204 may, for example, be included as part of or within a security identification document according to certain further embodiments of this disclosure.

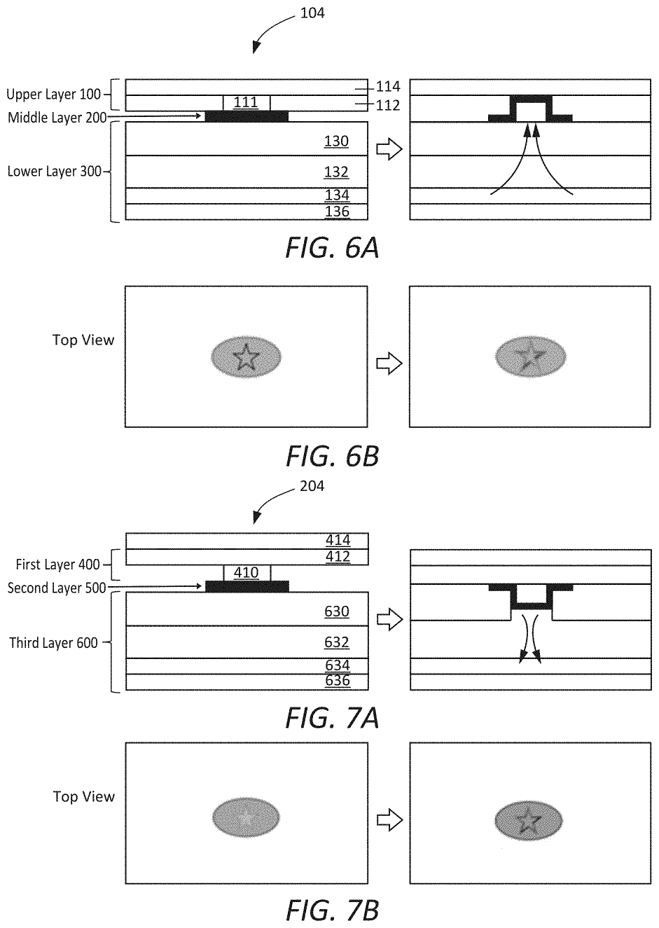

FIG. 6A, left and right images, are before and after schematic cross-sectional views of an authentication device 104 being formed in accordance with various embodiments of this disclosure involving a shaped cutout area 111, as shown. The FIG. 6A left image shows exemplary component layers of device 104 and corresponding thicknesses thereof, for example. As a specific example illustrated, second polymer film layer 130 of lower layer 300 is shown in FIG. 6A being comprised of a White polymer film layer that is 7 mil in thickness (e.g., 0.007 inches, or approximately 0.1778 millimeters). The FIG. 6A right image illustrates the deformation of middle layer 200 (including the visually deformable layer) that may occur during the fusing/lamination process (e.g., the fusing together of upper layer 100 and lower layer 300 upon exposure to heat). FIG. 6B, left and right images, are before and after top views of an authentication device 104 formed in accordance with some embodiments of this disclosure.

FIG. 7A, left and right images, are before and after schematic cross-sectional views of an authentication device 204 being formed in accordance with various embodiments of this disclosure involving a shaped chad layer 410, as shown. The FIG. 7A left image shows exemplary component layers of device 204 and corresponding thicknesses thereof, for example. The FIG. 7A right image illustrates the deformation of second layer 500 (including the visually deformable layer) that may occur during the fusing/lamination process (e.g., the fusing together of first layer 400 and third layer 600 upon exposure to heat). FIG. 7B, left and right images, are before and after top views of an authentication device 204 formed in accordance with some embodiments of this disclosure.

Some embodiments of this disclosure include incorporation into or onto a security document. Security documents may include, for example, passports, identification cards, drivers' licenses, credit cards, currency, title documents, stock, marriage, or birth certificates, and security, warranty/fraud detection, or brand and asset protection labels among other security documents. The following examples are provided to help describe how the concepts disclosed hereinabove may be applied in a number of different applications. The examples are intended to be illustrative only and are not intended to limit the scope of the accompanying claims.

Example 1: “Blaze” colored mirror film (“CMF”), made by the 3M Company, is a color-shifting reflective film that appears to be cyan in transmission and red in reflection, which changes when tilted to certain angles to magenta in transmission and yellow in reflection. Blaze film is approximately 30 microns thick. Unembossed Blaze film was coated with an adhesive and converted into 19 mm oval pieces. One oval was adhered to a sheet of Rowland PC (polycarbonate) film that was 180 microns thick. Another sheet of 100-micron Rowland PC film had two 5 mm stars cut out of the PC. The cut-out sheet was placed adjacent to the CMF sheet and other 100-micron PC sheets were added to the stack so that a final thickness of approximately 762 microns (not including the oval inlay) was achieved in a construction similar to what is represented in FIG. 2D. The resulting construction is substantially as previously described and shown (in cross-section) in FIG. 6A, with the left image showing the various layers before lamination. This arrangement was then laminated in a OASYS OLA6E press using the following process steps and corresponding conditions:

TABLE 1

| | | | Hold | Temp Ramp | Pressure |
|---|---|---|---|---|---|
| | Final | Final | Time | Time (s), | Ramp Time (s), |
| Step | T (° C.) | P (psi) | (sec) | approx | approx |
| 0 | Ambient | 0 | | | |
| 1 | 185 | 30 | | 165 | 5 |
| 2 | 185 | 30 | 30 | | |
| 3 | 185 | 80 | | | 3 |
| 4 | 185 | 80 | 320 | | |
| 5 | 165 | 80 | | 37 | |
| 6 | 163 | 160 | | 5 | 5 |
| 7 | 38 | 160 | | 503 | |
| 8 | 38 | 160 | 80 | | |
| 9 | 36 | 0 | | 5 | 5 |

This lamination process resulted in fusing of the PC layers together. The shaped cut-out had apparently been filled in by the security film (e.g., the Blaze CMF film) and by the polymer material from adjacent layers as other PC flowed into the cut-out area in a manner similar to what is represented in FIG. 2E as there were no visible pockets of air. The CMF film was apparently embossed by this process, generating the embossed star image shown in FIGS. 3A and 3B.

In a slight variation of the above method, the same construction and conditions of Example 1 (above) were performed except that no adhesive was used so that the CMF film could be removed after the lamination process in order to measure the thickness of the PC above and below the embossment. The resulting optical effect was the same as in Example 1, and the embossed CMF was indelibly marked. After cutting apart the fused card, the thickness of the PC on the side of the cut-out (e.g., above the cutout, as shown as the region above section 2c in FIG. 2E) was 574 microns immediately above where the cut-out was and was 602 microns away from the embossment area (e.g., the region above sections 2a/2e in FIG. 2E). On the opposite side from the cutout, the thickness of the PC measured 100 microns away from the embossment (e.g., the region below sections 2a/2e in FIG. 2E) and 190 microns immediately below where the cut-out was (e.g., as shown as the region below section 2c in FIG. 2E). This demonstrates that the PC on one side of the CMF embossment is thicker not only than the PC on the other side of the embossment but is also unexpectedly thicker than the initial PC layer in that local region; similarly, the PC where the cut-out was is also thinner than the initial PC layers on that side of the CMF.

In another example similar to the one formed and described above with respect to Example 1, a fused sample was generated with the following modifications. The “Blaze” colored mirror film (“CMF”), made by the 3M Company was replaced in this sample with a 1.0 mil polyester film that had been vacuum coated with a reflective aluminum layer, and which had no adhesive. The aluminized polyester deformable layer was approximately 14 mm in diameter. The 4.0 mil PC sheet had one cut out star approximately 7 mm across. The resulting fused laminate included a single star embossed according similarly to FIGS. 3A and 3B.

Example 2: Another fused sample similar to that formed in Example 1 was made except that the construction did not feature any shaped cut-out areas. Instead, the star-shaped materials that were cut out of the layers of Example 1 (e.g., star-shaped “chads”) were placed to form a small chad layer adjacent to the CMF layer for Example 2. This can be seen in the layered construction shown in the left image of FIG. 7A, with chad layer 410 adjacent the CMF layer (e.g., second layer 500). The same lamination process conditions as used in Example 1 (Table 1, above) were employed to fuse the PC together. The area around the star-shaped chad had apparently been filled in by the security film (CMF film) and the polymer from adjacent layers as that PC material flowed in a manner similar to what is represented in FIG. 2G. Unexpectedly, the thickness of the top layers above the CMF where the chad was located was approximately 25 microns thicker than the thickness of the top layers above the CMF but away from where the chad was located. The CMF was apparently debossed by this process, generating a debossed star image similar to that shown in the right image of FIG. 7B.

Example 3: Unembossed Blaze CMF film was coated with an adhesive and converted into 19 mm oval pieces. One oval was placed onto a polyvinyl chloride (“PVC”) film that was 63.5 microns thick. Another sheet of 63.5-micron PVC film had two 5 mm stars cut out of it. The cut-out sheet was placed adjacent to the CMF oval and other PVC sheets were added to the stack so that a final thickness of approximately 762 microns (not including the CMF) was achieved. This stack was then laminated in an OASYS OLA6E press using the following process steps and corresponding conditions:

TABLE 2

| | | | Hold | Temp Ramp | Pressure |
|---|---|---|---|---|---|
| | Final | Final | Time | Time (s), | Ramp Time (s), |
| Step | T (° C.) | P (psi) | (sec) | approx | approx |
| 0 | Ambient | 0 | | | |
| 1 | 149 | 20 | | 111 | 4 |
| 2 | 149 | 20 | 30 | | |
| 3 | 149 | 130 | | | 12 |
| 4 | 149 | 130 | 320 | | |
| 5 | 38 | 130 | | 568 | |
| 6 | 36 | 0 | | 5 | 5 |

After the lamination process using the steps and conditions of Table 2 above, the PVC was fused together. The cut-out area had apparently been filled in by the security film (e.g., the Blaze CMF) and polymer from adjacent layers as the CMF inlay was pushed through the star-shaped opening by the PVC below it. Some PVC in the cutout layer and potentially above it also flowed into the cut-out area smoothing out the edges slightly in a manner similar to that represented in FIG. 2G. Similar to Example 1, the card thickness did not vary more than 1% across the card dimensions. The CMF was apparently embossed by this process, generating a star image similar to those shown in FIGS. 3A and 3B.

Example 4: Another fused sample similar to that formed in Example 1 was generated, except in this case, the sheet containing the cut-out area was a sheet of 50 micron PET that had been laser imaged with a 5 mm eagle using a UV laser. The laser settings were adjusted so that the PET was locally melted, causing a raised, textured eagle image. During lamination, the eagle embossed the CMF.

Example 5: Another fused sample similar to that formed in Example 1 was generated except only using clear PC and Blaze CMF film that had first been printed with a 2 mm wide black rectangle across its width using UV flexography. The CMF was visually embossed as in Example 1, although the embossment effect was very difficult to see in areas where the ink had been printed. A UV laser was then used to image/etch the black ink in the fused document with the number “76,” ablating the ink away and leaving the underlying CMF film exposed. The CMF color did not seem affected significantly by the laser imaging. As the fused sample used clear PC, the laser imaged area presented interesting optics in that, when it was placed over a white background, the “76” etched pattern appeared to be cyan in color (i.e., the transmitted color), but when it was placed over a black background, the “76” pattern appeared to be red in color (i.e., the reflected color). This was also true when a white light source was placed behind the sample formed in Example 5, generating a cyan color (i.e., the transmitted color). An iPhone with a half black/half white picture on the view screen was placed behind Example 5, and the “76” pattern appeared to be cyan over the white image and red over the black image. In addition, the embossment effect appeared in different colors when placed over the white and black regions of the iPhone picture, providing an interesting authentication technique.

In a variation of Example 5, another sample was made where the Blaze CMF was first coated with a thin layer of aluminum instead of printed. This variation performed in a manner similar to Example 5.

Example 6: Another fused sample similar to the one formed in Example 1 was generated, except the cut-out sheet was a 4 mil PC sheet that was sent through the lamination process while placed against a silicone lamination mat that had an array of raised features approximately 0.8 mm×1.0 mm and separated by about 1.3 mm in the short direction and 1.7 mm in the long direction, respectively. The embossed PC sheet had pockets that were approximately 0.8 mm×0.9 mm at the same spacing as the mat. The resulting embossment in the Blaze CMF film appeared as raised hemispheroids at the same spacing. Since the embossed PC sheet covered essentially the whole fused sample, a white layer (7 mil PC) adjacent to the inlay was also embossed as well. This created a unique effect on the white layer which is not necessarily evident without sidelighting. Thus, this may provide another useful and/or convenient authentication technique.

Example 7: A fused sample was created similar to the one formed in Example 6, except that the white layer was replaced with a printed layer. The resulting embossments also occurred on the printed layer and formed the same pattern on the printed layer as on the CMF film.

Various examples have been described. These and other variations that would be apparent to those of ordinary skill in this field are within the scope of this disclosure.

What is claimed is:

1. An authentication device comprising:
An upper layer comprising a first non-opaque polymer film layer, the upper layer having a first thickness and an upper layer area, the first non-opaque polymer film layer having at least one shaped cutout area disposed therein;
a middle layer comprising a visually deformable layer, the middle layer having a second thickness, the middle layer having a middle layer area sized to at least partially cover the at least one shaped cutout area of the first non-opaque polymer film layer; and
a lower layer comprising a second polymer film layer, the lower layer having a lower layer area, the lower layer having a third thickness greater than the first thickness of the upper layer, and each of the upper layer area and the lower layer area being sized to cover the middle layer area;
wherein the authentication device is formed by:
positioning a second side of the middle layer adjacent a first side of the first non-opaque polymer film layer of the upper layer to at least partially cover the shaped cutout area,
positioning a first side of the middle layer adjacent a second side of the second polymer film layer of the lower layer; and
exposing at least the upper layer and the lower layer to a fusion temperature that is higher than a glass transition temperature of at least one of the upper layer and the lower layer to thereby fuse the upper layer and the lower layer together.

2. The authentication device of claim 1 wherein the visually deformable layer is configured to deform when the upper layer and lower layer are fused together to generate an optical effect.

3. The authentication device of claim 1 wherein the first non-opaque polymer film layer is a transparent polymer film layer.

4. The authentication device of claim 1 wherein the upper layer further comprises one or more additional non-opaque polymer film layers disposed adjacent the second side of the first non-opaque polymer film layer of the upper layer.

5. The authentication device of claim 4 wherein at least one of the first non-opaque polymer film layer and the one or more additional non-opaque polymer film layers of the upper layer comprises a security feature comprising one or more of a print, hologram, and color-shifting foils.

6. The authentication device of claim 4 wherein at least one of the first non-opaque polymer film layer and the one or more additional non-opaque polymer film layers of the upper layer is formed of a material selected from the group consisting of polycarbonate, polyvinyl chloride (“PVC”), and polyester.

7. The authentication device of claim 1 wherein the lower layer further comprises one or more additional polymer film layers disposed adjacent the first side of the second polymer film layer of the lower layer.

8. The authentication device of claim 7 wherein at least one of the second polymer film layer and the one or more additional polymer film layers of the lower layer comprises a security feature comprising one or more of a print, hologram, and color-shifting foils.

9. The authentication device of claim 7 wherein at least one of the second polymer film layer and the one or more additional polymer film layers of the lower layer is formed of a material selected from the group consisting of polycarbonate, polyvinyl chloride (“PVC”), polyester, Teslin® and/or other waterproof synthetic printing media, paper, and adhesives.

10. The authentication device of claim 1 wherein the visually deformable layer comprises a colored mirror film.

11. The authentication device of claim 1 wherein the visually deformable layer comprises a vapor-coated metal layer.

12. The authentication device of claim 1 wherein the visually deformable layer comprises a vapor-coated metal layer and a colored mirror film layer, and wherein at least a portion of the vapor-coated metal layer is removed after the upper layer and the lower layer are fused together.

13. The authentication device of claim 12 wherein the removed portion of the vapor-coated metal layer is removed using a laser etching process.

14. The authentication device of claim 1 wherein an adhesive is applied between the upper layer and the middle layer to facilitate positioning of the middle layer relative to the at least one shaped cutout area.

15. The authentication device of claim 1 wherein an adhesive is applied between the middle layer and the lower layer to facilitate positioning of the lower layer relative to the middle layer.

16. The authentication device of claim 1 wherein the middle layer area is sized to encompass the shaped cutout area.

17. The authentication device of claim 1 wherein the visually deformable layer comprises a colored mirror film (CMF) portion having a first major surface and a second major surface opposite the first major surface, the CMF portion comprising a multilayer optical film extending from the first major surface to the second major surface, the multilayer optical film comprising alternating first and second optical polymeric layers, each of the first optical polymeric layers having a first refractive index, and each of the second optical polymeric layers having a second refractive index different from the first refractive index.

18. The authentication device of claim 1 wherein the visually deformable layer is deformed along a boundary of the shaped cutout area of the upper layer thereby creating an optical effect resembling an embossment.

19. The authentication device of claim 1 wherein the authentication device is included within a security identification document.

20. The authentication device of claim 1 wherein, after fusing the upper layer and the lower layer together, a portion of the upper layer directly above both the shaped cutout area and the middle layer has a resulting fourth thickness that is less than a resulting fifth thickness of a portion of the upper layer that is above the middle layer but not above the shaped cutout area.

21. An authentication device comprising:
a shaped chad layer, the shaped chad layer comprising a polymer film having a chad first side and a chad second side, the shaped chad layer having a shaped chad thickness and a shaped chad area;
a first layer comprising a first non-opaque polymer film layer, the first layer having a first thickness and a first layer area,
a second layer comprising a visually deformable layer, the second layer having a second thickness and a second layer area having a second layer edge boundary sized to at least partially cover the shaped chad layer, the first layer area of the first layer being sized to cover the second layer area, and the second layer having a first side and a second side; and
a third layer comprising a third polymer film layer, the third layer having a third layer area sized to cover the second layer area, the third layer having a third thickness greater than the first thickness;
wherein the authentication device is formed by:
positioning the chad first side of the shaped chad layer adjacent the second side of the second layer so that the second layer edge boundary at least partially covers the shaped chad layer;
positioning the chad second side of the shaped chad layer adjacent the first side of the first non-opaque polymer film layer of the first layer;
positioning the third polymer film layer of the third layer adjacent the first side of the second layer to cover the second layer area; and
exposing at least the first layer and the third layer to a fusion temperature that is higher than a glass transition temperature of at least one of the first layer and the third layer.

22. The authentication device of claim 21 wherein the first layer comprises one or more additional non-opaque polymer film layers disposed adjacent the second side of the first non-opaque polymer film layer of the first layer.

23. The authentication device of claim 22 wherein at least one of the first non-opaque polymer film layer and the one or more additional non-opaque polymer film layers of the first layer comprises a security feature comprising one or more of a print, hologram, and color-shifting foils.

24. The authentication device of claim 22 wherein at least one of the first non-opaque polymer film layer and the one or more additional non-opaque polymer film layers of the first layer is formed of a material selected from the group consisting of polycarbonate, polyvinyl chloride (“PVC”), and polyester.

25. The authentication device of claim 21 wherein the third layer comprises one or more additional polymer film layers disposed adjacent the first side of the third polymer film layer of the third layer.

26. The authentication device of claim 25 wherein at least one of the third polymer film layer and the one or more additional polymer film layers of the third layer comprises a security feature comprising one or more of a print, hologram, and color-shifting foils.

27. The authentication device of claim 25 wherein at least one of the third polymer film layer and the one or more additional polymer film layers of the third layer is formed of a material selected from the group consisting of polycarbonate, polyvinyl chloride (“PVC”), polyester, Teslin® and/or other waterproof synthetic printing media, paper, and adhesives.

28. The authentication device of claim 21 wherein the authentication device is included within a security identification document.

29. The authentication device of claim 21 wherein, after exposing the first layer and the third layer to the fusion temperature, a portion of the third layer below the second layer but not under the shaped chad layer has a resulting fourth thickness that is greater than a resulting fifth thickness of a portion of the third layer that is directly below the shaped chad layer.

30. A method of manufacturing an authentication device comprising:
providing an upper layer comprising a first non-opaque polymer film layer, the upper layer having a first thickness and an upper layer area, the first non-opaque polymer film layer having at least one shaped cutout area disposed therein;
providing a middle layer comprising a visually deformable layer, the middle layer having a second thickness, the middle layer having a middle layer area sized to at least partially cover the at least one shaped cutout area of the first non-opaque polymer film layer of the upper layer; and
providing a lower layer comprising a second polymer film layer, the lower layer having a lower layer area, the lower layer having a third thickness greater than the first thickness of the upper layer, and each of the upper layer area and the lower layer area being sized to cover the middle layer area;
positioning a second side of the middle layer adjacent a first side of the first non-opaque polymer film layer of the upper layer to at least partially cover the shaped cutout area;
positioning a first side of the middle layer adjacent a second side of the second polymer film layer of the lower layer; and
exposing at least the upper layer and the lower layer to a fusion temperature that is higher than a glass transition temperature of at least one of the upper layer and the lower layer to thereby fuse the upper layer and the lower layer together.
